(19) United States
(12) Patent Application Publication
(10) Pub. No.: US 2008/0285074 A1
(43) Pub. Date: Nov. 20, 2008

(54) SYSTEMS, DEVICES, AND METHODS FOR VARIABLE DATA PRINTING

(75) Inventor: Jonathan R. Wilson, Cambridge (GB)

Correspondence Address: DARBY & DARBY P.C., P.O. BOX 770, Church Street Station, New York, NY, 10008-0770, US

(73) Assignee: Global Graphics Software Limited, Cambridge (GB)

(21) Appl. No.: 12/106,947

(22) Filed: Apr. 21, 2008

Related U.S. Application Data
(60) Provisional application No. 60/913,085, filed on Apr. 20, 2007.

(51) Int. Cl. G06F 3/12

(52) U.S. Cl. 358/1.15

(57) ABSTRACT

A method of printing a document comprising a plurality of pages, the plurality of pages comprising invariant data and variable data, wherein invariant data is data that is presented on each of at least two of the plurality of pages and variable data is data that is presented on only a single page, includes:

a) for each page of the plurality of pages, determining whether invariant data, if any, on that page has been previously rendered to a raster and, if not, rendering the invariant data to a raster and using that raster, in c) below, for the invariant data when present on other pages of the plurality of pages;

b) for each page of the plurality of pages, rendering, to a raster, variable data, if any, of that page; and

c) for each page of the plurality of pages, merging the rasters rendered for the invariant data, if any, and variable data, if any, of that page.

### CROSS-REFERENCE TO RELATED APPLICATIONS

This application claims the benefit under 35 USC 119(e) of U.S. Provisional Patent Application Ser. No. 60/913,085 filed on Apr. 20, 2007, which is herein incorporated by reference.

### FIELD

The present invention is directed to methods, systems, and devices that can be used for variable data printing including methods, systems, and devices that derive information used to identify invariant data automatically.

### BACKGROUND

Variable Data Printing or VDP (also known as Variable Information Printing, or VIP) is a form of on-demand printing in which elements such as text, graphics and images may be changed from one printed piece to the next without stopping or slowing down the press, using information from a database or external file. For example, a set of personalized letters, each with the same basic layout, can be printed with a different name and address on each letter. Variable data printing is often used for direct marketing, customer relationship management and advertising.

In many VDP implementations each page is constructed from: a) invariant graphical elements, that appear in exactly the same way in the same position on every page, or on a significant sub-set of the pages; and b) variable elements, which vary on every page. Thus a personalized brochure may comprise invariant elements such as a background image, a company logo and text that are intended for all recipients. Each individual instantiation of that brochure, intended for a different recipient, could also include the name and address of that recipient, and text constructed specifically for them. If the brochure contains multiple pages there may be a number of sets of invariant graphical elements; one for each page. Thus a four page brochure may be based on four distinct sets of invariant graphical elements. A large number of variations on this theme are possible.

For many years it has been expected that variable data printing (VDP) would become a very important part of the output from commercial print establishments. In practice VDP is being adopted rather slowly, and most of that adoption is concentrated into a relatively small number of organizations that have specialized in delivery of VDP work. This appears to be for two reasons: 1) successful implementation of VDP solutions requires expertise in graphic design, database management and mining, and in printing (relatively few organizations can bring all three of these to the table); and 2) a very large number of data formats are in use for delivery of data from VDP creation applications to the digital printers used for producing the hard copy output.

This latter reason may mean that a company using multiple printing devices from different manufacturers must use multiple creation applications (a different creation tool for each printing device) in order to match the data format created to the capabilities of each printing device. That situation leads to increased training and integration costs and to reduced efficiency. It may also lead to an inability to access certain functionality that is available on one printing device, but not on another because of a lack of corresponding functionality in the associated creation tool.

Data formats in common use for VDP include, but are not limited to, Xerox's Variable Data Intelligent Postscript Printware (VIPP), EFI's Fiery FreeForm, Kodak (Creo)'s Variable Print Specification (VPS), PODi's Personalized Print Markup Language (PPML) and Personalized Print Markup Language/Variable data eXchange (PPML/VDX, standardized as ISO 16612).

In addition, many creation tools can generate data streams using page description languages such as Adobe System's PostScript language and Portable Document Format (PDF). In these cases it's common for those graphic elements which are re-used many times (e.g. because they are on every copy of a personalized letter) to be encapsulated in a “form” object so that the page description for that element need only be included once in the data stream. These formats are typically more portable than the formats designed explicitly for VDP, but often offer somewhat lower performance. Use of form objects in this way is not widely supported outside of tools that are specifically designed for VDP. Using widely available tools such as the mail merge support in applications such as Microsoft Office Word and printing to PostScript from there will not make use of form objects, for instance. Even where a PDL includes form objects, those objects do not include metadata that identifies how a set of forms are used together to construct the invariant data for each page of the personalized data to be printed.

### BRIEF SUMMARY

One embodiment is a method of printing a document comprising a plurality of pages, the plurality of pages comprising invariant data and variable data, wherein invariant data is data that is presented on each of at least two of the plurality of pages and variable data is data that is presented on only a single page. The method includes:

a) for each page of the plurality of pages, determining whether invariant data, if any, on that page has been previously rendered to a raster and, if not, rendering the invariant data to a raster and using that raster, in c) below, for the invariant data when present on other pages of the plurality of pages;

b) for each page of the plurality of pages, rendering, to a raster, variable data, if any, of that page; and

c) for each page of the plurality of pages, merging the rasters rendered for the invariant data, if any, and variable data, if any, of that page.

Another embodiment is a method of printing a document comprising a plurality of pages. The method includes:

a) for each page of the plurality of pages, computing a hash value for an element set, if any, of that page;

b) for each page of the plurality of pages, determining whether the hash value for the element set of that page matches the hash value of an element set for another one of the pages and, if so, determining where the element set with the matching hash value has been previously rendered to a raster and, if not, rendering, to a raster, the element set and using that raster, in d) below, for the element set when present on other pages of the plurality of pages;

c) for each page of the plurality of pages, rendering, to a raster, the element set of the page if the hash value that does not match any hash value of any element set of any other page, as well as rendering, to that raster, any elements of the page that are not in the element set; and

d) for each page of the plurality of pages, merging the rasters rendered for the element set of the page and all other elements of the page.

A further embodiment is a computer-readable medium having processor-executable instructions for performing actions corresponding to any one of the methods described above.

Yet another embodiment is a system that is operative to print a document. The system includes at least one processor for executing processor-readable instructions that enable actions to perform any one of the methods described above.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a flow-chart of one embodiment of a method of variable data printing, according to the invention;

FIG. 2 is a flow-chart of a second embodiment of a method of variable data printing, according to the invention; and

FIG. 3 is a graphical representation of one embodiment of a system for variable data printing, according to the invention.

### DETAILED DESCRIPTION

The present invention is directed to methods, systems, and devices that can be used for variable data printing including methods, systems, and devices that derive information used to identify invariant data automatically. The methods, systems, and devices may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of computing device that includes a processor or any combination of computing devices where each device performs at least part of the process.

Suitable computing devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

In contrast to conventional methods and systems, the present invention enables jobs created in a variety of page description languages (PDLs), including (but not limited to) PostScript, PDF and Microsoft's XML Paper Specification (XPS), to be processed rapidly and efficiently, without requiring the use of form objects.

When a PDL file is presented for output, it is parsed multiple times:
a) once to characterize the graphical elements used on each page; (This pre-pass is designed to identify the invariant items on the page.)
b) once to interpret and render (collectively described herein as ripping) the invariant elements that are common between multiple pages; and
c) once to rip (raster image process) the variable elements on each page and to merge the result with the raster of the invariant elements.

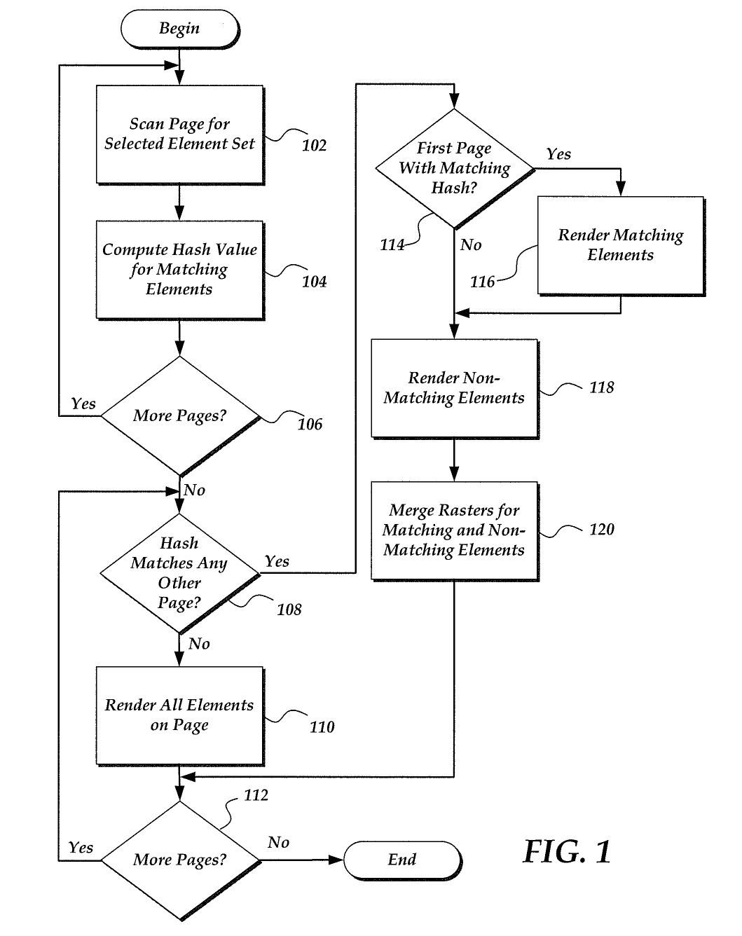

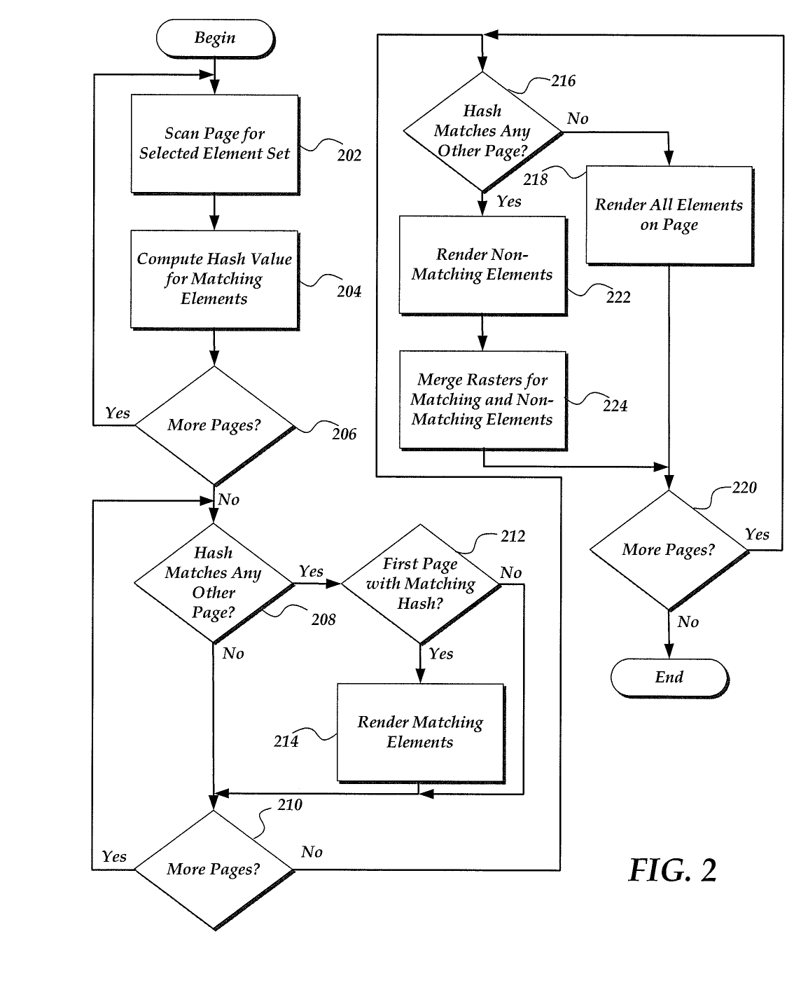

In one embodiment, the second and third of these passes are combined into one pass (see FIG. 1). In another embodiment, the second and third passes are separate (see FIG. 2).

When processing most PDLs for print, the most computationally expensive and slowest process is often rendering; in comparison an additional pre-pass through the file is typically a lightweight process and does not typically cause a significant reduction in performance.

The pre-pass and the ripping processes may be performed in series within a single product on a single computer, or may be separated across multiple computers and/or separated in time. For example, the pre-pass procedure may be applied to a job when it is initially presented to the digital front end (DFE) of a printing device, but the ripping performed at some later time, such as immediately before the job is to be physically printed.

In the pre-pass each page is analyzed in turn. The analysis detects graphical elements on the page, and identifies a subset of those elements that match pre-determined criteria. In one embodiment, the selected subset comprises all images on the page. In another embodiment, the selected subset comprises all non-text elements (i.e. all image and vector graphics elements). In yet another embodiment, the subset comprises all elements that are included in the same order as an initial subset of graphical elements on the first page of the job, thus dynamically constructing the desired set of elements from the contents of the job itself. A variety of other criteria can be envisaged.

The analysis may be performed in a number of different ways. In one embodiment, it is an examination of the stream of graphical operators and their operands, as parsed from the PDL. In another embodiment, it is by examination of the display list constructed as a result of parsing the PDL for each page.

As is explained below, a variety of different techniques may be used to construct complete pages from combinations of variable and invariant graphic elements. Some of those techniques may be limited in that certain combinations of elements may merge incorrectly. As an example, an implementation that simply renders one raster for all invariant items and one raster for all variable items, but that does not include a mask channel or data that identifies which object any specific pixel in the raster was derived from, cannot cope with variable white text that is placed over the top of invariant graphic elements. In such a case the system or apparatus may choose to examine the variable data elements and to treat all data on the page as variable if a problematic construct is found in the variable data,

In one embodiment, as part of identifying the set of elements matching the defined criteria on each page a hash function is computed for those elements. A hash function is a mechanism to enable a complex data set to be compared easily and efficiently with another complex data set to determine whether they are the same or not. In one embodiment, the hash is based on an MD5 checksum for the data identified, and stored as a GUID or UUID (Globally Unique Identifier or Universally Unique Identifier). In another embodiment, the data itself is used for comparisons, and may therefore be regarded as its own hash value. A wide variety of other hash creation methodologies and other methods of identifying matching sets of elements may be used.

Each page in the PDL is parsed in turn, resulting in a collection of hash values, one for every page.

In the second and third passes through the PDL the hash value for each page is compared with the hash values for all other pages in the job. If the hash value is unique then the page is treated as unique and is simply ripped as a single entity.

If the hash value matches that of other pages, then it is determined whether this is the first page with that hash value in this job. If it is, the graphical elements that match the defined criteria are ripped and an output raster produced that represents just those elements. If the hash value matches that of a previously processed page, then the raster for those elements has already been created and need not be produced again. It is this methodology; avoiding the re-ripping of specified graphical elements; that can yield efficiency gains.

In one embodiment, and in the case where the page has been identified as containing invariant data, the variable elements on the page, if any, are ripped to generate a second raster. The raster representing invariant elements is then merged with the second raster representing variable elements in order to construct a raster representing the whole page. The generated raster and the merging may make use of mask channels as well as printable colorant channels in order to allow the present invention to be used with constructs such as variable white text knocking out underlying invariant graphics.

In another embodiment the raster representing the invariant elements is pre-loaded into virtual memory before the variant data for the page is rendered, and the variable elements are rendered in-situ into the same virtual memory, thus implicitly merging the two sets of elements. This embodiment may also address white variable text knocking out invariant elements.

After the raster for each whole page is created it may be processed in any way that the resulting raster from a more conventional ripping process in a DFE might be processed. Such processing options include retention on the DFE for later printing, transfer to another computer for printing from there (e.g. when the RIP is described as an off-line RIP because it is not directly connected to a printing device), or direct submission to a printing device, with or without additional imposition of pages to reduce media usage. In some embodiments the submission to a printing device may be concurrent with the creation of the combined raster.

At the end of the job, any retained rasters can be deleted, if desired, and the associated data structures freed. It should also be noted that data structures may be deleted during the ripping phase if lack of available memory dictates, and that it is possible for retained raster files to be deleted if space on disk becomes too scarce. In this case they may simply be regenerated as needed for later pages.

FIG. 1 illustrates one embodiment of a method of variable data printing. A page is scanned for a selected element set (step 102) and the hash value for the matching elements (e.g., the selected element set) is computed, as described above (step 104). This is repeated for each page in the job (step 106). The method continues by determining whether the hash from the first page matches any other page (step 108). If not, then all elements of the page are rendered (step 110) and the process proceeds to the next page (step 112). If the hash does match another page, the method determines whether this is the first page with the matching hash (step 114). If it is the first page with the matching hash, then the matching elements are rendered to a raster (step 116), the non-matching elements are rendered to a raster (step 118) and the rasters for the matching and non-matching elements are merged (step 120). If the page is not the first page with the matching hash, then the matching elements have already been rendered when a previous page was processed and so the non-matching elements of the present page can be rendered to a raster (step 118) and the rasters for the matching and non-matching elements are merged (step 120). The process then proceeds to the next page (step 112) until all pages are rendered.

FIG. 2 illustrates another embodiment of a method of variable data printing. A page is scanned for a selected element set (step 202) and the hash value for the matching elements (e.g., the selected element set) is computed, as described above (step 204). This is repeated for each page in the job (step 206). The method continues by determining whether the hash from the first page matches any other page (step 208). If not, then this determination is repeated successively for each page (step 210). If the hash does match another page, the method determines whether this is the first page with the matching hash (step 212) and, if so, renders the matching elements to a raster (step 214). The process proceeds through all of the pages (step 210). Next, the process determines whether the hash of the first page matches any other page (step 216). If not, then all of the elements of the page are rendered (step 218) and the process proceeds to the next page (step 220). If the hash does match another page, then the non-matching elements are rendered to a raster (step 222) and the rasters for the matching and non-matching elements are merged (step 224). The process proceeds to the next page (step 220) until all pages are rendered.

It will be understood that each block of the flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The computer program instructions, or portions of the computer program instructions, can be stored on any suitable computer-readable medium including, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

An image (for example, a page or other object) can be printed on a medium such as, for example, paper, foil, plastic, fabric, metal, wood, ceramic, and the like. The image can be printed by any printing method including, but not limited to, ink jet printing, laser printing, flexographic printing, lithographic printing, gravure printing, screen printing, pad printing, and the like. The image can include, but is not limited to, pictures, text, graphics, and any combination thereof.

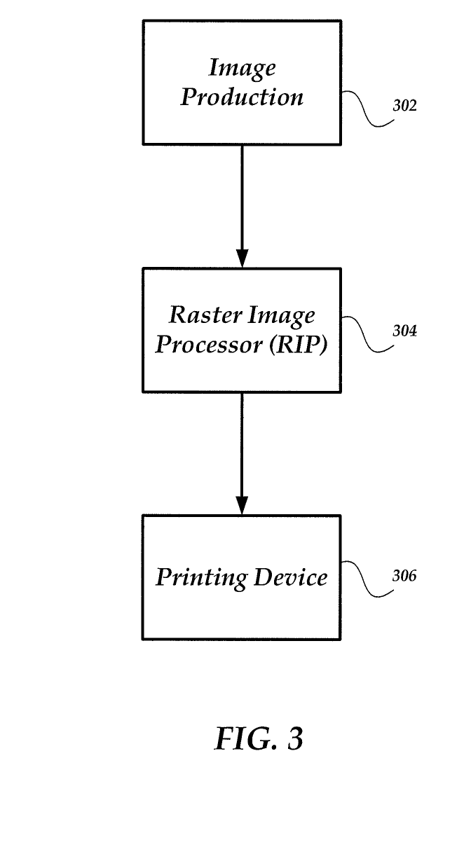

One example of an arrangement for variable data printing is schematically illustrated in FIG. 3. Each of the components in FIG. 3 can be achieved using hardware, software, or a combination thereof. In addition, the individual components can be separate or combined with one or more of the other illustrated components into a single device. For example, the image production system 302 and raster image processor 304 can be combined on a single computer or the raster image processor 304 can be provided on a computer that controls a printing device 306 or different portions of the raster image processor 304 may be on the image production system 302 and printing device 306 (or even a stand-alone device). The components, individually or in any combination, can include, but are not limited to, a processor, a memory unit, and optionally an input unit. The memory unit can be any suitable storage device selected from removable and non-removable storage devices including, but not limited to, a hard drive, a diskette, a compact disc, a memory stick, random access memory, and the like. The input unit can be any suitable device for inputting information into the component including, but not limited to, a keyboard, mouse, touch-screen, disk drive, memory stick, compact disk drive, and the like.

An image production system 102 produces, procures, or otherwise prepares data (e.g., images, text, photos, graphics, and the like) for printing. The data can be provided as a digital file in any suitable format including, but not limited to, a byte map, or a file in PDL or PCL format. The data is provided to a raster image processor 104 which processes the data to form one or more rasters as described above.

The raster image processor 104 provides the raster(s) to a printing device 106 which then prints the data. The raster(s) can be provided to the printing device as they are being generated, or with a delay, or when the raster(s) are complete. Raster(s) can be provided for each ink of a printing device separately or the rasters of one or more colors can be combined into a single raster using, for example, an interleaved format. When individual rasters for each color are provided to the printing device, these rasters can be provided sequentially or simultaneously (for example, using interleaved or parallel delivery.) The rasters (for example, a page or other object) can be printed on a medium such as, for example, paper, foil, plastic, fabric, metal, wood, ceramic, and the like. The rasters can be printed by any printing method including, but not limited to, ink jet printing, laser printing, flexographic printing, lithographic printing, gravure printing, screen printing, pad printing, and the like.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is;

1. A method of printing a document comprising a plurality of pages, the plurality of pages comprising invariant data and variable data, wherein invariant data is data that is presented on each of at least two of the plurality of pages and variable data is data that is presented on only a single page, the method comprising:
a) for each page of the plurality of pages, determining whether invariant data, if any, on that page has been previously rendered to a raster and, if not, rendering the invariant data to a raster and using that raster, in c) below, for the invariant data when present on other pages of the plurality of pages;
b) for each page of the plurality of pages, rendering, to a raster, variable data, if any, of that page; and
c) for each page of the plurality of pages, merging the rasters rendered for the invariant data, if any, and variable data, if any, of that page.

2. The method of claim 1, further comprising printing the pages of the document from the merged rasters of each page.

3. The method of claim 1, wherein, for each page of the plurality of pages, a), b), and d) are performed for that page prior to performing a), b), or c) for a next page of the plurality of pages.

4. The method of claim 1, wherein a) is performed for all pages of the plurality of pages prior to performing b) or c) for any page of the plurality of pages.

5. A method of printing a document comprising a plurality of pages, the method comprising:
a) for each page of the plurality of pages, computing a hash value for an element set, if any, of that page;
b) for each page of the plurality of pages, determining whether the hash value for the element set of that page matches the hash value of an element set for another one of the pages and, if so, determining where the element set with the matching hash value has been previously rendered to a raster and, if not, rendering, to a raster, the element set and using that raster, in d) below, for the element set when present on other pages of the plurality of pages;
c) for each page of the plurality of pages, rendering, to a raster, the element set of the page if the hash value that does not match any hash value of any element set of any other page, as well as rendering, to that raster, any elements of the page that are not in the element set; and
d) for each page of the plurality of pages, merging the rasters rendered for the element set of the page and all other elements of the page.

6. The method of claim 5, further comprising printing the pages of the document from the merged rasters of each page.

7. The method of claim 5, wherein, for each page of the plurality of pages, b), c), and d) are performed for that page prior to performing b), c), or d) for a next page of the plurality of pages.

8. The method of claim 5, wherein b) is performed for all pages of the plurality of pages prior to performing c) or d) for any page of the plurality of pages.

9. The method of claim 5, wherein the element set of each page consist of all images on that page.

10. The method of claim 5, wherein the element set of each page consists of all non-text elements of that page.

11. The method of claim 5, wherein the element set of each page consists of all elements of an initial element set determined for the first page of the plurality of pages.

12. The method of claim 5, wherein the hash value is a checksum value.

13. The method of claim 5, wherein the hash value is data of the element set.

14. A computer-readable medium having processor-executable instructions for printing a document comprising a plurality of pages, the plurality of pages comprising invariant data and variable data, wherein invariant data is data that is presented on each of at least two of the plurality of pages and variable data is data that is presented on only a single page, the processor-executable instructions when installed onto a system enable the system to perform actions, comprising:
a) for each page of the plurality of pages, determining whether invariant data, if any, on that page has been previously rendered to a raster and, if not, rendering the invariant data to a raster and using that raster, in c) below, for the invariant data when present on other pages of the plurality of pages;
b) for each page of the plurality of pages, rendering, to a raster, variable data, if any, of that page; and
c) for each page of the plurality of pages, merging the rasters rendered for the invariant data, if any, and variable data, if any, of that page.

15. A system that is operative to print a document comprising a plurality of pages, the plurality of pages comprising invariant data and variable data, wherein invariant data is data that is presented on each of at least two of the plurality of pages and variable data is data that is presented on only a single page, the system comprising:
at least one processor for executing processor-readable instructions that enable actions, including:
a) for each page of the plurality of pages, determining whether invariant data, if any, on that page has been previously rendered to a raster and, if not, rendering the invariant data to a raster and using that raster, in c) below, for the invariant data when present on other pages of the plurality of pages;
b) for each page of the plurality of pages, rendering, to a raster, variable data, if any, of that page; and
c) for each page of the plurality of pages, merging the rasters rendered for the invariant data, if any, and variable data, if any, of that page.

16. The system of claim 15, further comprising a computing device and a printing device coupled to the computing device, wherein the at least one processor is provided in at least one of the computing device or the printing device.

17. The system of claim 16, wherein a), b), and c) are performed on a single processor.

18. The system of claim 17, wherein the single processor is provided in the computing device.

19. The system of claim 17, wherein the single processor is provided in the printing device.

20. The system of claim 15, wherein the at least one processor comprises a first processor provided in the computing device and a second processor provided in the printing device.
